(19) United States
(12) Patent Application Publication
(10) Pub. No.: US 2006/0122353 A1
(43) Pub. Date: Jun. 8, 2006

(54) Method of producing a modified diisocyanate,method of producing a self-lubricating enamelling varnish and method of producing an enameled electrical conductor

(76) Inventors: Virginie Studer, Chassieu (FR); Arnaud Piechaczyk, Lyon (FR); Laurent Schildknecht, Lyon (FR)

Correspondence Address: SOFER & HAROUN LLP., 317 MADISON AVENUE, SUITE 910, NEW YORK, NY, 10017, US

(21) Appl. No.: 10/528,298

(22) PCT Filed: Sep. 19, 2003
(86) PCT No.: PCT/FR03/02767

§ 371 Date: Jan. 23, 2006

(30) Foreign Application Priority Data
Sep. 20, 2002 (FR) 0211643

(51) Int. Cl. C08G 18/00

(52) U.S. Cl. 528/44

(57) ABSTRACT

The present invention relates to a process for preparing a modified diisocyanate to which is attached a pendant aliphatic chain containing at least 15 carbon atoms, said modified diisocyanate being obtained by reacting an isocyanate functional group of a triisocyanate with a terminal functional group of an aliphatic chain; to a process for preparing a self-lubricating insulating varnish; and to a process for producing an enameled electrical conductor.

The present invention pertains to a process for preparing a modified diisocyanate, to a process for preparing a self-lubricating insulating varnish, and to a process for producing an enameled electrical conductor.

In the manufacture of electric motors, the greater the extent to which a large amount of winding wire can be incorporated in the core of the stator, the better the performance of the motor. Moreover, motor manufacturers also desire an increase in the production yield. Accordingly, in a conventional manner, these windings are introduced automatically into the stators.

The wires used in these electric motors are typically composed of an electrical conductor coated with one or more insulating layers based on insulating varnish.

These enameled wires are wound at very high speeds and are therefore subject to high levels of friction and mechanical stresses, which may damage their insulation and lead to nonuniform winding.

In order to solve this problem it is known, from the document EP 0072178, to produce the outer insulation of these winding wires by means of an insulating varnish having a low friction coefficient, providing the desired slip properties.

This varnish, which may be termed a self-lubricating varnish, is composed of a polymer of polyamide-imide polyester or polyester-imide type, in accordance with the examples, the polymer being modified by comprising an alkyl end group having a linear chain of 21 to 31 carbon atoms, in accordance with the examples.

The modified polymer is obtained by mixing, in a solvent medium of N-methylpyrrolidone (NMP) type, an aliphatic acid such as docosanoic acid or such as montan wax or alkyl ester with the monomers used to form polymers, such as trimellitic anhydride, and diisocyanate.

The modified polymer is also obtained by mixing, in a solvent medium of xylene type, alkyl ester such as methyl behenate with the monomers used to form polymers, such as dimethyl terephthalate, ethylene glycol and glycerol.

Nevertheless, according to the abrasion tests presented, the extent to which this self-lubricating varnish, when applied to a conducting wire, can be overcoated is low. Because of this adhesion problem, the varnish cannot be applied in two or more passes, without detriment to the mechanical properties of the enameled conducting wire.

Moreover, the resistance to solvent or to a refrigerant such as Freon of the enameled wire coated with such a varnish, in other words its chemical compatibility, is not tested. Similarly, the thermal properties (thermoplasticity, etc.), the insulating properties (tangent of the loss angle) and stability are not guaranteed.

Furthermore, the document JP5101713 provides a self-lubricating insulating varnish comprising a modified polyamide imide to which is attached a pendant aliphatic chain having more than 17 carbon atoms.

The chain is pendant since it is attached by only one of its ends to the polyamide imide, to form a branch.

The pendant chain or chains confer the desired slip properties on the insulating varnish. However, the mechanical, thermal and electrical insulation properties of the varnishes obtained are not presented.

The process for preparing this varnish comprises the synthesis of a lubricating reactive derivative and subsequently the synthesis of the polyamide-imide.

A lubricating reactive derivative is synthesized by reacting a compound having at least three reactive hydroxyl and/or carboxyl groups with another compound having a lubricating group and a group which reacts with one of these reactive groups.

This document describes more specifically, in the detailed examples, these other compounds which have a lubricating group and also a reactive isocyanate group. These other compounds are obtained after the reaction of a diisocyanate with a montanic or stearic acid.

Obtaining the lubricating reactive derivative therefore first entails the formation of these other compounds and, furthermore, requires filtering and crystallizing operations, resulting in a process for preparation of the modified polyamide-imide, and hence of the varnish, which is slow and complex.

The aim of the present invention is therefore to develop, on the basis of a preparation process which is compatible with industrial requirements, a stable, self-lubricating insulating varnish which is easy to apply as a coating and can be overcoated, said varnish thus having mechanical, thermal and electrical insulation properties comparable with those of conventional non-lubricated varnishes, and a low friction coefficient.

The present invention provides for this purpose a process for preparing a modified diisocyanate to which is attached a pendant aliphatic chain containing at least 15 carbon atoms, the modified diisocyanate being obtained by reacting an isocyanate functional group of a triisocyanate with a terminal functional group of an aliphatic chain.

The process according to the invention allows a modified diisocyanate to be obtained in a single, simple step.

The triisocyanate according to the invention is particularly reactive and therefore allows complete reaction, guaranteeing the aforementioned desired properties for the end polymer.

Naturally, the reaction takes place in the absence of difunctional monomer (or with negligible amount).

Advantageously, said preparation of the modified diisocyanate can be carried out in a solvent medium (for example, a solvent capable of blocking two of the three isocyanate functions) with stirring and heating.

According to one characteristic, said terminal functional group is selected from alcohols, anhydrides, carboxylic acids and amines.

The present invention likewise provides a process for preparing a self-lubricating insulating varnish comprising a modified polymer comprising a base polymer to which is attached a pendant aliphatic chain containing at least 15 carbon atoms, said process being characterized in that it comprises the following steps:
preparing a modified diisocyanate as defined above,
mixing said modified isocyanate with at least one difunctionalized monomer containing two functional groups which are reactive with said isocyanate functional groups of the modified diisocyanate, to carry out said synthesis of said modified polymer.

Thus the preparation of a self-lubricating insulating varnish is simplified by virtue of the process according to the invention.

The modified diisocyanate according to the invention carries no risk of preventing the formation of a long polymeric main chain by polycondensation and hence of limiting the performance of the self-lubricating insulating varnish.

Moreover, the triisocyanate makes it possible to prepare a wide range of polymers.

Thus said base polymer may be a polyamide-imide or else may be selected from polyurethanes, polyamides, polyesters, polyester-imides, solderable polyester-imides, polyester amide-imides, polyimides, polyepoxide compounds and polyphenoxide compounds.

The base polymer may also be a semiaromatic polyamide and the so-called anchor group attaching the base polymer to said pendant aliphatic chain may be a urethane or an amide, such that said self-lubricating insulating varnish is thermally adhering.

A varnish of this kind may be used for applications involving a high level of resistance to partial discharges.

Advantageously, when the base polymer is a polyurethane, the process may further comprise a step of mixing the modified polyurethane with a polymer selected from a solderable polyester-imide and a modified solderable polyester-imide.

A difunctionalized monomer containing two functional groups similar to the isocyanate functional groups of the modified diisocyanate may be mixed with said modified diisocyanate.

The invention provides, finally, a process for producing an enameled electrical conductor, said process being characterized in that it comprises the following steps:
a step of preparing the self-lubricating insulating varnish as defined above,
a step of coating an electrical conductor with a layer of the self-lubricating insulating varnish.

Other characteristics and advantages of the present invention will emerge from the following description of a number of examples of insulating varnishes according to the invention, of an electrical conductor coated with a layer of self-lubricating insulating varnish according to the invention, and the process for preparing the self-lubricating insulating varnish according to the invention, including the preparation of the modified diisocyanate, these examples being given by way of illustration and in no way of limitation.

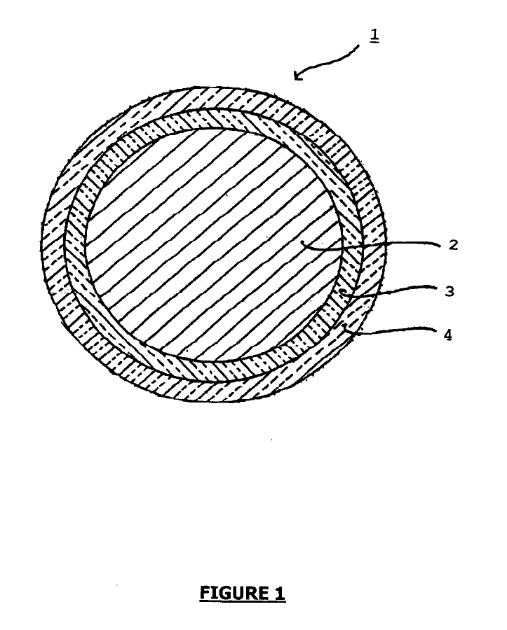

FIG. 1 shows a cross-sectional view of a conductor produced on the basis of the process according to the invention.

The conductor 1 comprises a conductive electrical core 2, made of copper for example, coated with a layer of varnish 3, comprising a conventional insulating varnish, which is in turn coated with a layer of self-lubricating insulating varnish 4, obtained according to one of examples 1 to 8 below, according to the invention, carried out in two passes. The number of passes is not limited and depends on the end use of the wire and on the desired characteristics. The layer 4 of varnish according to the invention is always the outer coating layer of the conductor 1, since it provides the slip properties.

The conductor 1 may of course comprise one or more other varnish layers (not shown) other than the layer 3 under the varnish layer 4 according to the invention, and may also be coated directly with the single varnish layer 4 according to the invention.

### EXAMPLE 1

This example 1 describes the process for preparing a self-lubricating insulating varnish of modified polyamide-imide type, comprising the polyamide-imide base polymer to which are attached pendant aliphatic chains each containing 18 carbon atoms. The so-called anchor group attaching this base polymer to each pendant aliphatic chain is a urethane.

696 g of N-methylpyrrolidone (NMP), 204 g of HDI isocyanurate (Lyondell Luxate HT2000 or Bayer Desmodur N3300) and then 95 g of octadecanol are introduced into a heated and stirred reactor atop which there is a condenser. The mixture is heated and stirred at 100° C. for 1 hour. The alcohol function of the octadecanol reacts with one of the isocyanate functions of the triisocyanate to form a modified diisocyanate to which the aliphatic chain is attached by the urethane anchor group.

The modified diisocyanate thus formed is subsequently introduced into a reactor for the synthesis of the polyamide-imide, by replacement of a variable portion of the diisocyanates (MDI, TDI, etc.), and reacts in the same way with the diacids and anhydrides present in the medium. This synthesis is entirely conventional and is well known to the skilled worker. It will not, therefore, be described in any more detail here.

The number of isocyanate functions in the medium is substantially equal to the number of carboxylic acid functions. In this example 1, the modified diisocyanate replaces a part of the MDI, to give a stable, clear, self-lubricating insulating varnish having a solids content of 31% and a viscosity of 1700 mPa·s at 20° C.

### EXAMPLE 2

This example 2 describes the process for preparing a self-lubricating insulating varnish of modified polyamide-imide type, comprising the polyamide-imide base polymer to which are attached pendant aliphatic chains each containing 18 carbon atoms. The so-called anchor group attaching this base polymer to each pendant aliphatic chain is an amide.

349 g of N-methylpyrrolidone (NMP), 110 g of HDI isocyanurate (Lyondell Luxate HT2000 or Bayer Desmodur N3300) and then 54 g of stearic acid (Akzo Nobel Kortacid 1895, for example) are introduced into a heated and stirred reactor atop which there is a condenser. The mixture is heated and stirred at 150° C. for 1 hour. The carboxylic acid function reacts with one of the isocyanate functions of the triisocyanate to form a modified diisocyanate to which the aliphatic chain is attached by the amide anchor group.

This modified diisocyanate thus formed is subsequently introduced into the synthesis of the polyamide-imide, by replacement of a variable portion of the diisocyanates (MDI, TDI, etc.), and reacts in the same way with the diacids and anhydrides present in the medium. This synthesis is entirely conventional and is well known to the skilled worker. It will not, therefore, be described in any more detail here.

The number of isocyanate functions in the medium is substantially equal to the number of carboxylic acid functions. In this example 2, the modified diisocyanate replaces a part of the MDI, to give a stable, clear, self-lubricating insulating varnish having a solids content of 30% and a viscosity of 1400 mPa·s at 20° C.

EXAMPLE 3

This example 3 describes the process for preparing a self-lubricating insulating varnish which is thermally adhering, of modified semiaromatic polyamide-imide type, comprising the semiaromatic polyamide base polymer to which are attached pendant aliphatic chains each containing 18 carbon atoms.

The so-called anchor group attaching this base polymer to each pendant aliphatic chain is a urethane.

430 g of N-methylpyrrolidone (NMP), 125 g of HDI isocyanurate (Lyondell Luxate HT2000 or Bayer Desmodur N3300) and then 59 g of octadecanol are introduced into a heated and stirred reactor atop which there is a condenser. The mixture is heated and stirred at 100° C. for 1 hour. The alcohol function reacts with one of the isocyanate functions of the triisocyanate to form a diisocyanate on which the aliphatic chain is attached by the urethane anchor group. This diisocyanate thus formed will subsequently be introduced into the synthesis of the polyamide, by replacement of a variable portion of the diisocyanates (MDI, TDI, etc.), and will react in the same way with the dicarboxylic acids present in the medium. This synthesis is entirely conventional and is well known to the skilled worker. It will not, therefore, be described in any more detail here. Reference may be made for this, for example, to the document U.S. Pat. No. 4,505,978.

The number of isocyanate functions in the medium is substantially equal to the number of carboxylic acid functions.

In this example 3, the modified diisocyanate replaces a part of the MDI, to give a stable, clear, thermally adhering, self-lubricating insulating varnish having a solids content of 25% and a viscosity of 2000 mPa·s at 20° C. The (mass of aliphatic chain)/(mass of polymer base) ratio is 6.7%.

### EXAMPLE 4

This example 4 describes the process for preparing a self-lubricating insulating varnish of modified solderable polyamide-imide type, comprising the polyamide-imide base polymer, which is solderable, and hence contains no THEIC (trishydroxyethyl isocyanurate), and to which are attached pendant aliphatic chains each containing 28 carbon atoms. The so-called anchor group attaching this base polymer to each pendant aliphatic chain is an amide.

900 g of N-methylpyrrolidone (NMP), 229.4 g of HDI isocyanurate (Lyondell Luxate HT2000 or Bayer Desmodur N3300) and then 177 g of montanic acid are introduced into a heated and stirred reactor atop which there is a condenser. The mixture is heated and stirred at 150° C. for 1 hour. The carboxylic acid function reacts with one of the isocyanate functions of the triisocyanate to form a modified diisocyanate to which the aliphatic chain is attached by the amide anchor group.

This modified diisocyanate thus formed is subsequently introduced at the first phase of the entirely conventional synthesis of the polyester-imide, by replacement of a variable portion of the diisocyanates (MDI), and reacts in the same way with the anhydrides present in the medium (forming imide groups) . The second phase of this synthesis is entirely conventional and is well known to the skilled worker. It will not, therefore, be described in any more detail here.

The number of isocyanate functions in the medium is substantially equal to the number of anhydride functions. In this example 4, the modified diisocyanate replaces a part of the MDI, to give a stable, clear, self-lubricating insulating varnish having a solids content of 44% and a viscosity of 2300 mPa·s at 20° C.

### EXAMPLE 5

This example 5 describes the process for preparing a self-lubricating insulating varnish of modified solderable polyester-imide type, comprising the polyester-imide base polymer, without THEIC, to which are attached pendant aliphatic chains each containing 28 carbon atoms. The so-called anchor group attaching this base polymer to each pendant aliphatic chain is an amide.

700 g of cresol, 229.4 g of HDI isocyanurate (Lyondell Luxate HT2000 or Bayer Desmodur N3300) and then 177 g of montanic acid are introduced into a heated and stirred reactor atop which there is a condenser. The mixture is heated and stirred at 200° C. for 1 hour. The carboxylic acid function reacts with one of the isocyanate functions of the triisocyanate to form a modified diisocyanate to which the aliphatic chain is attached by the amide anchor group.

This modified diisocyanate thus formed is subsequently introduced at the first phase of the entirely conventional synthesis of the polyester-imide, by replacement of a variable portion of the diisocyanates (MDI), and reacts in the same way with the anhydrides present in the medium (forming imide groups) . The second phase of this synthesis is entirely conventional and is well known to the skilled worker. It will not, therefore, be described in any more detail here.

The number of isocyanate functions in the medium is substantially equal to the number of anhydride functions. In this example 5, the modified diisocyanate replaces a part of the MDI, to give a stable, clear, self-lubricating insulating varnish having a solids content of 44% and a viscosity of 1850 mPa·s at 20° C.

### EXAMPLE 6

This example 6 describes the process for preparing a self-lubricating insulating varnish of THEIC-modified polyester-imide type, comprising the polyester-imide base polymer, containing THEIC, to which are attached pendant aliphatic chains each containing 28 carbon atoms. The so-called anchor group attaching this base polymer to each pendant aliphatic chain is an amide.

700 g of cresol, 229.4 g of HDI isocyanurate (Lyondell Luxate HT2000 or Bayer Desmodur N3300) and then 177 g of montanic acid are introduced into a heated and stirred reactor atop which there is a condenser. The mixture is heated and stirred at 200° C. for 1 hour. The carboxylic acid function reacts with one of the isocyanate functions of the triisocyanate to form a modified diisocyanate to which the aliphatic chain is attached by the amide anchor group.

This modified diisocyanate thus formed is subsequently introduced at the first phase of the entirely conventional synthesis of the polyester-imide, by replacement of a variable portion of the diisocyanates (MDI), and reacts in the same way with the anhydrides present in the medium (forming imide groups) . The second phase of this synthesis is entirely conventional and is well known to the skilled worker. It will not, therefore, be described in any more detail here.

The number of isocyanate functions in the medium is substantially equal to the number of anhydride functions. In this example 6, the modified diisocyanate replaces a part of the MDI, to give a stable, clear, self-lubricating insulating varnish having a solids content of 43% and a viscosity of 2050 mPa·s at 20° C.

### EXAMPLE 7

This example 7 describes the process for preparing a self-lubricating insulating varnish of modified polyurethane type, comprising the polyurethane base polymer, to which are attached pendant aliphatic chains each containing 28 carbon atoms, blended with a polyester-imide containing no THEIC. The so-called anchor group attaching this base polymer to each pendant aliphatic chain is an amide.

264 g of cresol, 67.4 g of HDI isocyanurate (Lyondell Luxate HT2000 or Bayer Desmodur N3300) and then 52 g of montanic acid are introduced into a heated and stirred reactor atop which there is a condenser. The mixture is heated and stirred at 200° C. for 1 hour. The carboxylic acid function reacts with one of the isocyanate functions of the triisocyanate to form a modified diisocyanate to which the aliphatic chain is attached by the amide anchor group.

This modified diisocyanate thus formed is subsequently introduced into the synthesis of the polyurethane—or, to be more precise, blocked polyurethane-polyisocyanate—by replacement of a variable portion of the diisocyanates (MDI), and reacts in the same way with the polyols present in the medium (forming urethane groups). This synthesis is entirely conventional and is well known to the skilled worker. It will not, therefore, be described in any more detail here.

The number of isocyanate functions in the medium is substantially equal to twice the number of hydroxyl functions of the polyols, the free isocyanate functions being blocked with cresol.

The blocked polyurethane-polyisocyanate is blended in a 60/40 base/base ratio with a polyester-imide containing no THEIC, and then formulated. The resultant self-lubricating insulating varnish is a class H polyurethane having a solids content of 40% and a viscosity of 1800 mPa·s at 20° C.

### EXAMPLE 8

This example 8 describes the process for preparing a self-lubricating insulating varnish of modified polyurethane type, comprising the polyurethane base polymer, to which are attached pendant aliphatic chains each containing 28 carbon atoms, blended with the polymer of example 5. The so-called anchor group attaching this base polymer to each pendant aliphatic chain is an amide.

A blocked polyurethane-polyisocyanate, obtained as in example 7, is mixed in a 60/40 base/base ratio with the polyester-imide described in example 5, and then formulated. The resultant self-lubricating insulating varnish is a class H polyurethane having a solids content of 44% and a viscosity of 4500 mPa·s at 20° C.

Table 1 below gives the properties and test results of copper wires, with a diameter of approximately 0.56 mm, which were enameled without addition of external lubricant, under the following conditions:
enameling speed: 100 m/min,
12 passes of conventional THEIC polyester-imide varnish (19960 Nexans IVA), used as basecoat,
2 passes of self-lubricating varnishes as defined in examples 1 and 2 above.

For comparison, the results obtained with a conventional nonlubricating varnish of polyamide-imide type are also shown.

As desired, the mechanical, thermal and insulating properties of the self-lubricating varnishes of examples 1 and 2 are similar to those of the conventional nonlubricating varnish. In particular the abrasion resistance is satisfactory and the slip properties are improved.

Table 2 below gives the properties and test results of copper wires, with a diameter of approximately 0.50 mm, which were enameled without addition of external lubricant, under the following conditions:
enameling speed: 50 m/min,
6 passes of conventional THEIC polyester-imide varnish (19960 Nexans IVA), used as basecoat, in a first oven at 540° C.,
2 passes of the thermally adhering self-lubricating varnish as defined in example 3, as a topcoat, in a second oven at 360° C.

For comparison, the results obtained with a conventional nonlubricating thermally adhering varnish of semiaromatic polyamide type are also shown in table 2.

Table 3 below gives the properties and test results of copper wires, with a diameter of approximately 0.56 mm, which were enameled without addition of external lubricant, under the following conditions:
enameling speed: 100 m/min,
12 passes of self-lubricating varnishes as defined in examples 4 to 6 above.

For comparison, the results obtained with a conventional nonlubricating varnish A of solderable polyester-imide (19828 Nexans) and a conventional nonlubricating THEIC polyester-imide varnish B (19960 Nexans) are also shown.

As desired, the mechanical, thermal and insulating properties of the self-lubricating varnishes of examples 4 to 6 are similar to those of the conventional nonlubricating varnishes A and B. In particular the abrasion resistance is satisfactory and the slip properties are improved.

Table 4 below gives the properties and test results of copper wires, with a diameter of approximately 0.56 mm, which were enameled without addition of external lubricant, under the following conditions:
enameling speed: 134 m/min,
12 passes of self-lubricating varnishes as defined in examples 7 and 8 above.

For comparison, the results obtained with a conventional nonlubricating varnish C, which is a class H polyurethane (13090 Nexans), are also shown in table 4. As desired, the mechanical, thermal and insulating properties of the self-lubricating varnishes of the examples are similar to those of conventional varnish C. It will be appreciated that the present invention is not limited to the embodiments which have just been described.

Finally, any means may be replaced by an equivalent means, without departing from the scope of the present invention.

TABLE 1

| | Example 1 | Example 2 | Standard varnish |
|---|---|---|---|
| Number of carbon atoms per | 18 | 18 | — |
| aliphatic chain | | | |
| Overthickness of enamel (μm) | 49 | 48 | 49 |
| Abrasion resistance | 550 | 530 | 620 |
| Thermoplasticity | 475° C. | 470° C. | 470° C. |
| Bunch slip (CEI60851-3-B5) | 10 N | 12 N | 65 N |
| | | | (elongation of the |
| | | | wire) |
| Resistance to Freon R22 | YES | YES | YES |
| 72 h, 70° C., 30 bar | | | |

TABLE 2

| | Example 3 | Standard varnish |
|---|---|---|
| Number of carbon atoms per aliphatic | 18 | — |
| chain | | |
| Overthickness of thermally adhering | 19 | 20 |
| enamel (μm) | | |
| Binding strength at 20° C. (binding | 2.13 N | 2.2 N |
| 30 min at 200° C., CEI851-7) | | |
| Softening temperature (binding | 160° C. | 170° C. |
| 30 min at 200° C., CEI851-7) | | |
| Bunch slip (CEI60851-3-B5) | 21 N | 50 N |

TABLE 3

| | | | Standard | | Standard |
|---|---|---|---|---|---|
| | Example 4 | Example 5 | varnish A | Example 6 | varnish B |
| Number of carbon atoms per | 28 | 28 | — | 28 | — |
| aliphatic chain | | | | | |
| Overthickness of enamel (μm) | 60 | 61 | 59 | 60 | 59 |
| Flexibility 1 × D | 20% | 20% | 20% | 25% | 25% |
| Thermal shock at 200° C., 30 min | 15% | 15% | 15% | 15% | 15% |
| Abrasion resistance | 450 | 480 | 500 | 520 | 550 |
| Weldability at 475° C. | 4 s | 3.5 s | 4 s | — | — |
| Tangent delta (Dansk TD300) | 181° C. | 179° C. | 182° C. | 192° C. | 195° C. |
| Bunch slip (CEI60851-3-B5) | 10 N | 11 N | >60 N | 11 N | >60 N |

TABLE 4

| | Example 7 | Example 8 | Standard varnish C |
|---|---|---|---|
| Number of carbon atoms per aliphatic chain | 28 | 28 | — |
| Overthickness of enamel (μm) | 50 | 52 | 52 |
| Flexibility 1 × D | 20% | 20% | 20% |
| Thermal shock at 200° C., 30 min | 15% | 15% | 15% |
| Abrasion resistance | 380 | 350 | 415 |
| Weldability at 475° C. | 2 s | 2 s | 2.5 s |
| Tangent delta (Dansk TD300) | 162° C. | 164° C. | 165° C. |
| Bunch slip (CEI60851-3-B5) | 9 N | 7 N | >60 N (breakage of |
| | | | the wire |

1-10. (canceled)

11. A process for preparing a modified diisocyanate to which is attached a pendant aliphatic chain containing at least 15 carbon atoms, said process for obtaining said modified diisocyanate comprising the steps of:
reacting an isocyanate functional group of a triisocyanate with a terminal functional group of an aliphatic chain; and
carrying out said preparation of the modified diisocyanate in a solvent medium with stirring and heating.

12. The process for preparing a modified diisocyanate as claimed in claim 11, wherein said terminal functional group is selected from alcohols, anhydrides, carboxylic acids and amines.

13. A process for preparing a self-lubricating insulating varnish having a modified polymer comprising a base polymer to which is attached a pendant aliphatic chain containing at least 15 carbon atoms, said process comprising the following steps:
preparing a modified diisocyanate as claimed in claim 11; and
mixing said modified diisocyanate with at least one difunctionalized monomer containing two second functional groups which are reactive with the first isocyanate functional groups of the modified diisocyanate, to carry out said synthesis of said modified polymer.

14. The process for preparing a self-lubricating insulating varnish as claimed in claim 13, wherein said base polymer is a polyamide-imide.

15. The process for preparing a self-lubricating insulating varnish as claimed in claim 13, wherein said base polymer is selected from polyurethanes, polyamides, polyesters, polyester-imides, solderable polyester-imides, polyester amide-imides, polyimides, polyepoxide compounds and polyphenoxide compounds.

16. The process for preparing a self-lubricating insulating varnish as claimed in claim 13, wherein said base polymer is a semiaromatic polyamide and wherein the so-called anchor group attaching the base polymer to said pendant aliphatic chain is a urethane or an amide, such that said self-lubricating insulating varnish is thermally adhering.

17. The process for preparing a self-lubricating insulating varnish as claimed in claim 13, wherein, said base polymer being a polyurethane, the process further comprises a step of mixing the modified polyurethane with a polymer selected from a solderable polyester-imide and a modified solderable polyester-imide.

18. The process for preparing a self-lubricating insulating varnish as claimed in claim 13, wherein a difunctionalized monomer containing two functional groups similar to the isocyanate functional groups of the modified diisocyanate is mixed with said modified diisocyanate.

19. A process for producing an enameled electrical conductor, said process comprising the steps of:
preparing the self-lubricating insulating varnish as claimed in claim 13; and
coating an electrical conductor with a layer of the self-lubricating insulating varnish.
